(19) United States
(12) Patent Application Publication
(10) Pub. No.: US 2007/0215264 A1
(43) Pub. Date: Sep. 20, 2007

(54) Structure for and method of fixing elastic resin sheet

(75) Inventor: Kazushige Ueno, Ogaki (JP)

Correspondence Address: OLIFF & BERRIDGE, PLC, P.O. BOX 19928, ALEXANDRIA, VA, 22320, US

(73) Assignee: PACIFIC INDUSTRIAL CO., LTD., OGAKI-SHI (JP)

(21) Appl. No.: 11/493,580

(22) Filed: Jul. 27, 2006

(30) Foreign Application Priority Data
Mar. 20, 2006 (JP) 2006-076599

(51) Int. Cl. B32B 37/00; B29C 65/00

(52) U.S. Cl. 156/73.6

(57) ABSTRACT

A structure is disclosed for fixing an elastic resin sheet on a base member made of a synthetic resin so that the base member is covered with the elastic resin sheet. The structure includes a welding protrusion formed so as to protrude from a part covered with the elastic resin sheet in the base member. The welding protrusion has a distal end face to which the elastic resin sheet is vibration-welded.

### BACKGROUND OF THE INVENTION

1. Field of the Invention

The present invention relates to an elastic resin sheet fixing structure for and method of fixing an elastic resin sheet on a synthetic resin base member, and more particularly to structure for and method of vibration-welding nonwoven cloth made from polyethylene terephthalate (PET) as an elastic resin sheet to a base member.

2. Description of the Related Art

As one of conventional methods of fixing elastic resin sheet as described above, a fixing method by vibration welding is known. In this fixing method, an elastic resin sheet is laid on a base member, and a shaft-like vibration welding tool is caused to strike against an elastic resin sheet. A part of the elastic resin sheet is vibration-welded to a desired position on the base member. For example, JP-A-H10-216962 discloses one of such fixing methods.

However, in the above-mentioned conventional fixing method, the elastic resin sheet is melted throughout the thickness direction thereof in a welded part, whereupon a rather deep depression is formed in a part of the elastic resin sheet. Consequently, sound absorbency and elasticity of the elastic resin sheet are spoiled in and near the welded part. Furthermore, internal stress is generated in the elastic resin sheet, which becomes easy to break.

### SUMMARY OF THE INVENTION

Therefore, an object of the present invention is to provide an elastic resin sheet fixing structure and method both which can render the depression of the welded part shallower than in the prior art or can eliminate the depression.

In one aspect, the present invention provides a structure for fixing an elastic resin sheet on a base member made of a synthetic resin so that the base member is covered with the elastic resin sheet. The structure comprises a welding protrusion formed so as to protrude from a part covered with the elastic resin sheet in the base member, the welding protrusion having a distal end face to which the elastic resin sheet is vibration-welded.

In the above-described fixing structure, the welding protrusion to which the elastic resin sheet is welded protrudes from the base member. Accordingly, the welding protrusion is easily melted by vibration welding and a heating time can be shortened. Consequently, an amount of melted resin sheet can be suppressed and accordingly, the depression of the welded part in the elastic resin sheet can be rendered shallower than in the prior art or can be eliminated.

Furthermore, the welding protrusion is comprised of a plurality of protruding pieces, an assemblage of the protrusions or a cylinder, whereupon the welding protrusion can be rendered thinner. Consequently, each welding protrusion can be rendered more meltable. Furthermore, since a plurality of protruding pieces intersect each other, the protruding pieces reinforce each other such that the strength of the welding protrusion can be increased and accordingly, thickness of each protruding piece can be reduced and the welding protrusion can be more meltable.

Furthermore, the inventor found by experiment that the nonwoven cloth made from PET was suitable for a sound absorbing material against noise at 8 kHz. Thus, when the nonwoven cloth made from PET was fixed to a sound absorbing cover as the elastic resin sheet, the noise at 8 kHz could be attenuated effectively.

In another aspect, the invention provides a method of fixing an elastic resin sheet on a base member made of a synthetic resin so that the base member is covered with the elastic resin sheet. The method comprises protruding a welding protrusion from the base member, covering the base member with the elastic resin sheet and striking a vibration-welding tool having a bar-shaped distal end against the elastic resin sheet, and vibrating the vibration-welding tool while the elastic resin sheet is depressed between distal end faces of the vibration-welding tool and welding protrusion, thereby vibration-welding the elastic resin sheet to the welding protrusion.

The welding protrusion to which the elastic resin sheet is to be welded is protruded from the base member. The vibration welding is carried out while the elastic resin sheet is depressed between distal end faces of the vibration-welding tool and welding protrusion. Accordingly, the welding protrusion is easily melted and the heating time can be reduced. Consequently, an amount of melted resin sheet can be suppressed and accordingly, the depression of the welded part in the elastic resin sheet can be rendered shallower than in the prior art or can be eliminated.

Furthermore, the distal end face of the welding protrusion is broader than the distal end face of the vibration-welding tool. Consequently, even when the position of the vibration welding tool varies, the distal end face of the vibration welding tool remains within the distal end face of the welding protrusion, whereupon the welding strength can be stabilized.

### BRIEF DESCRIPTION OF THE DRAWINGS

Other objects, features and advantages of the present invention will become clear upon reviewing the following description of the embodiment, with reference to the accompanying drawings, in which:

FIG. 1 is a perspective of an engine and engine cover in accordance with one embodiment of the present invention;

FIG. 2 is a perspective view of a cover body;

FIG. 3 is a perspective view of the engine cover;

FIG. 4 is a perspective view of a welding protrusion;

FIG. 5 is a sectional view-of the engine cover;

FIG. 6 is also a sectional view of the engine cover;

FIG. 7 is a plan view of the welding protrusion employed in another embodiment of the invention;

FIG. 8 is a side section of the engine cover in further another embodiment of the invention; and

FIG. 9 is a side section of the engine cover in still further another embodiment of the invention.

### DETAILED DESCRIPTION OF THE INVENTION

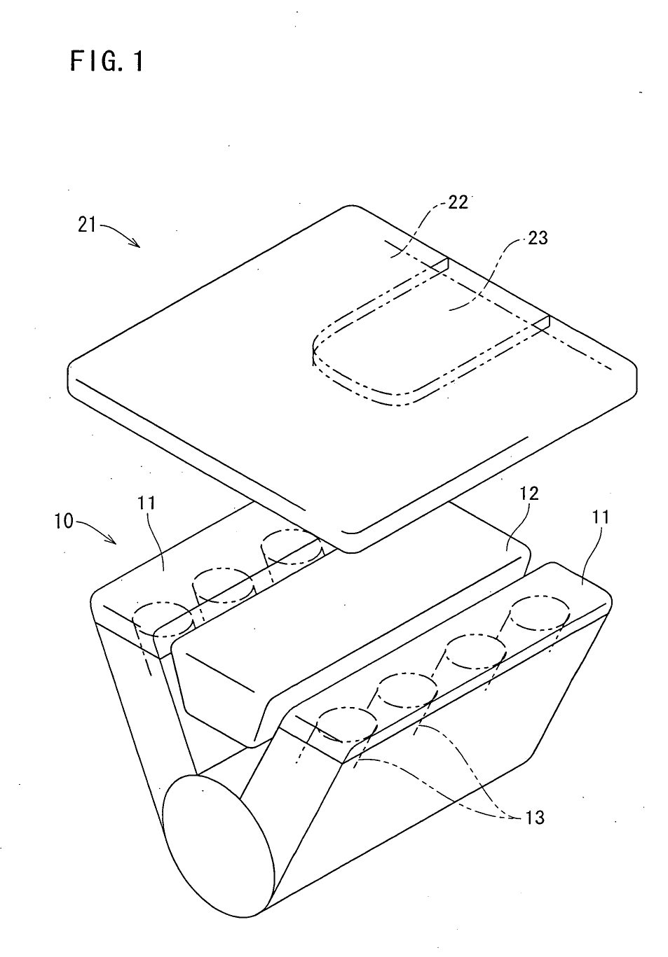

One embodiment of the present invention will be described with reference to FIGS. 1 to 6. Referring to FIG. 1, an engine cover 21 made from a synthetic resin is shown. The shown engine cover 21 serves as a base member and a sound-proof cover in the invention. The engine cover 21 is fixed to an engine 10 or a suitable component located near the engine 10 by screws (not shown) while covering an upper side of the engine 10. The engine 10 is a V-type direct-injection engine, for example and includes a pair of cylinder heads 11 mounted on an upper end thereof. An intake manifold 12 is assembled between the cylinder heads 11. Each cylinder 13 of the engine 10 is provided with a fuel injection valve and an air supply valve neither of which is shown. The intake manifold 12 includes pipes connected to the fuel injection valve and the air supply valve respectively. The pipe with one end connected to the fuel injection valve has the other end to which a high-pressure pump is connected.

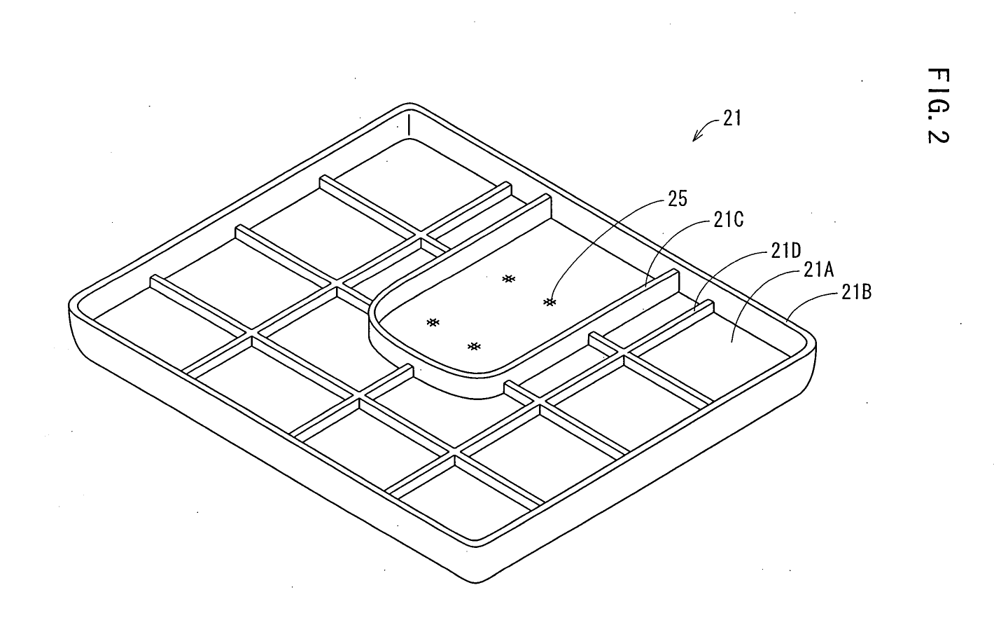

The engine cover 21 includes an urethane sound-absorber 22 and a PET sound-absorber 23 both facing to the engine 10. FIG. 2 shows the engine cover 21 before formation of the urethane sound-absorber 22 and the PET sound-absorber 23, as viewed at the underside thereof. As shown in FIG. 2, the engine cover 21 has such a structure that a surrounding wall 21B protrudes downward (upward in FIG. 2) from an outer edge of a substantially rectangular main plate 21A. The engine cover 21 has an underside with an area-defining rib 21C formed on a central part thereof with respect to the right-and-left direction (a direction of arrangement of the cylinder heads 11). The area-defining rib 21C is generally formed into a U-shape. The U-shaped rib 21C has an open end disposed on the outer edge of the main plate 21A and occluded by the surrounding wall 21B and a closed end disposed in the central part of the main plate 21A.

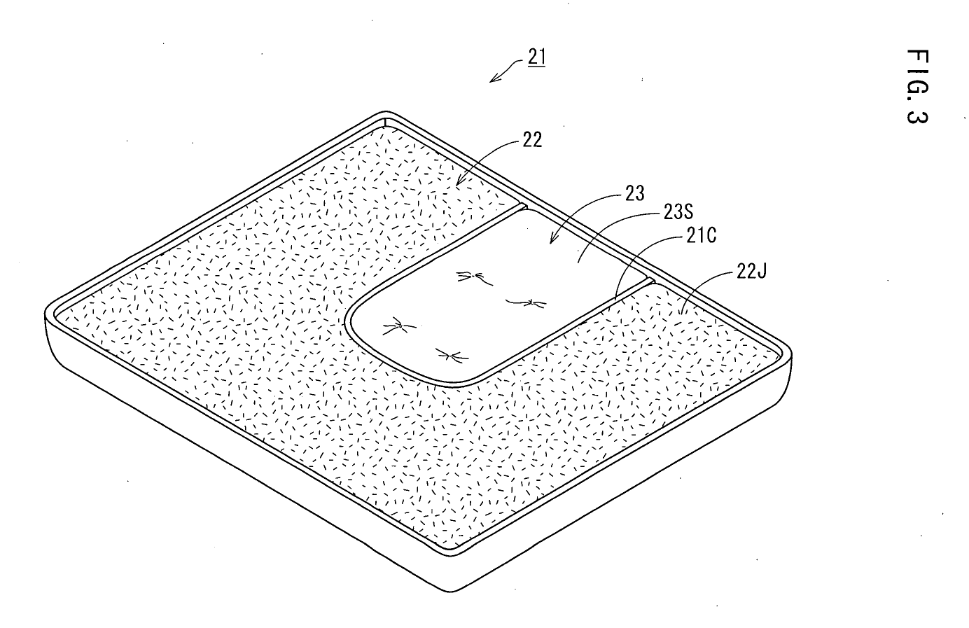

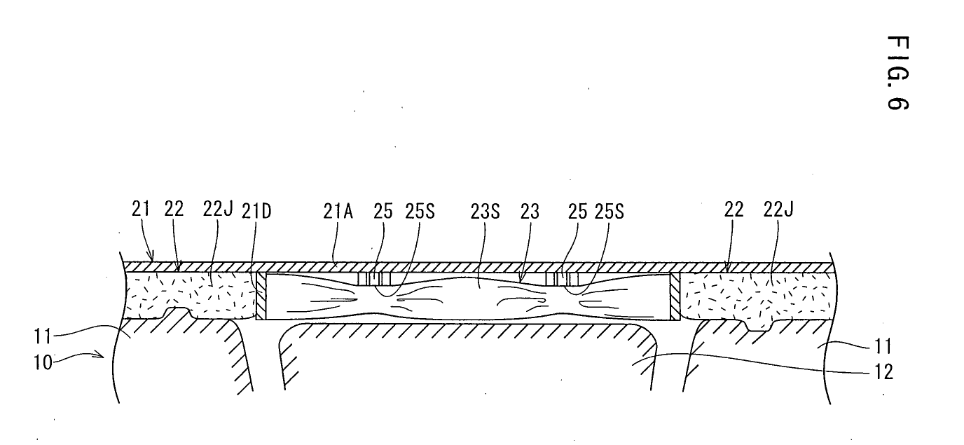

The underside of the engine cover 21 includes reinforcing ribs 21D provided on the whole area other than an inner area encompassed by the area-defining rib 21C. An urethane resin foam 22J is provided by molding on the whole area in which the reinforcing ribs 21D are formed, thereby serving as an urethane sound-absorber 22 shown in FIG. 3. The urethane sound-absorber 22 is applied to the paired cylinder heads 11 and one end of the intake manifold 12. Furthermore, the urethane sound-absorber 22 is formed with irregularities (not shown) which are engaged with irregularities formed on tops of the cylinder heads 11 and intake manifold 12, whereupon the entire urethane sound absorber 22 is adhered closely to parts of the cylinder heads 11 and intake manifold 12 (see FIG. 6).

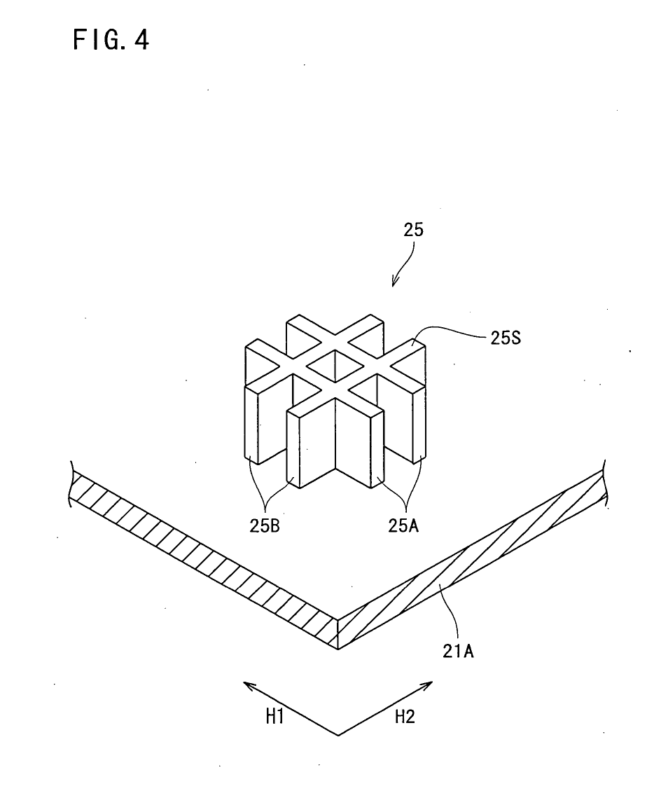

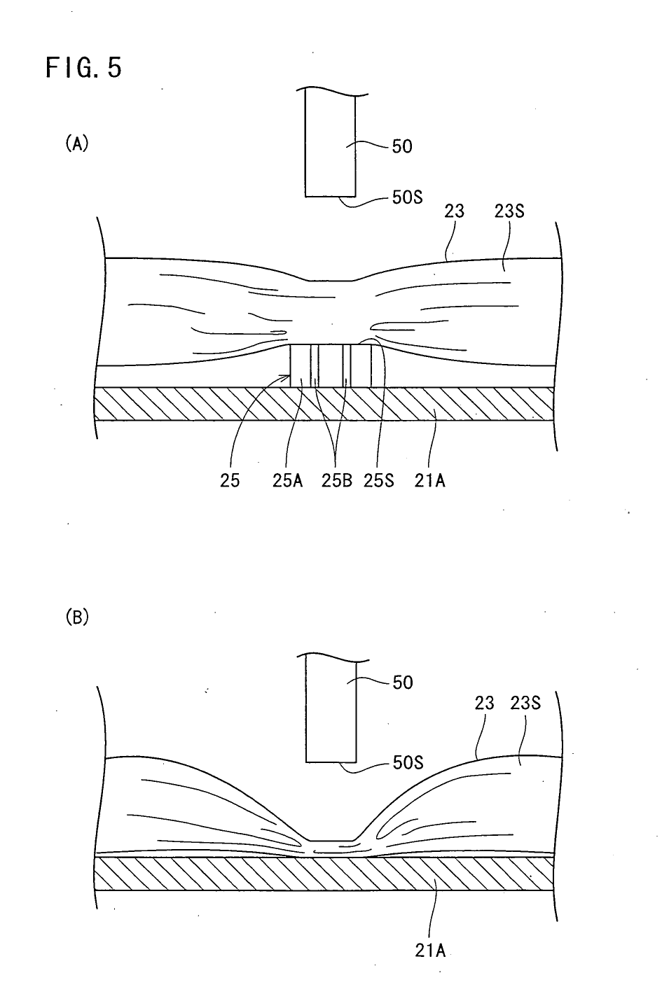

Referring now to FIG. 2, a plurality of welding protrusions 25 are dispersed in the inner area encompassed by the area-defining-rib 21C on the underside of the engine cover 21. The welding protrusions 25 include a plurality of protruding pieces 25A and 25B protruding from the underside of the engine cover 21 and intersecting each other into a lattice shape. More specifically, the welding protrusions 25 include a pair of protruding pieces 25A protruding from the underside of the engine cover 21 and extending in a first horizontal direction (the direction of arrow Hi in FIG. 4) in parallel with each other, another pair of protruding pieces 25B which extend in a second horizontal direction (the direction of arrow H2 in FIG. 4) so as to intersect at right angles with the first horizontal direction. The welding protrusions 25 thus have the planar shape of symbol “#.” Furthermore, each of the protruding pieces 25A and 25B has a larger horizontal length than a diameter of a distal end face 50S of a vibration welding tool 50 (see FIG. 5A) which will be described later. As a result, the distal end face 50S of the vibration welding tool 50 is sized so as to be encompassed within the area in which a plurality of the protruding pieces 25A and 25B both constituting the welding protrusion 25 are dispersed. More specifically, the welding protrusion 25 has a broader or larger distal end face 25S than the distal end face 50S of the vibration welding tool 50. Further, each of the protruding pieces 25A and 25B has a thinner thickness than the main plate 21A, the reinforcing rib 21D and the area-defining rib 21C.

The underside (corresponding to a sheet fixing face in the invention) of the engine cover 21 includes the inner area encompassed by the area-defining rib 21C which is covered with nonwoven cloth 23S made from PET (corresponding to an elastic resin sheet in the invention) and serving as a PET sound-absorber 23. The nonwoven cloth 23S is vibration-welded to the distal end face 25S of the welding protrusion 25 thereby to be fixed on the engine cover 21.

The PET sound-absorber 23 of the engine cover 21 is applied to an upper face of the intake manifold 12 of the engine 10, and the urethane sound-absorber 22 is applied to the cylinder heads 11 and a part of the intake manifold 12 as described above. Noise generated in the cylinder heads 11 upon drive of the engine 10 is absorbed by the urethane sound-absorber 22, whereas noise generated in the intake manifold 12 is absorbed by the PET sound-absorber 23. The noise generated in the intake manifold 12 of the V-type direct-injection engine 10 contains a frequency of 8 kHz as a main component. According to the embodiment, the noise generated in the intake manifold 12 can effectively be attenuated by the nonwoven cloth 23S made from PET.

A method of fixing the PET nonwoven cloth 23S on the engine cover 21 will now be described. As shown in FIG. 5A, the nonwoven cloth 23S is laid on the inner area encompassed by the area-defining rib 21C. The vibration-welding tool 50 having a bar-shaped distal end is caused to strike against the nonwoven cloth 23S. The nonwoven cloth 23S is depressed between the distal end faces 50S and 25S of the vibration-welding tool 50 and the welding protrusion 25. In this state, heat is applied to an abutment between the nonwoven cloth 23S and the welding protrusion 25 while the vibration-welding tool 50 is vibrated for a predetermined period of time, and thereafter, the vibration-welding tool 50 is removed.

FIG. 5B illustrates a case where the nonwoven cloth 23S is pressed against a part of the underside of the engine cover 21 without the welding protrusion 25 and vibration is produced. In this case, the pressed portion of the nonwoven cloth 23S would not be melted if the temperature around the pressed nonwoven cloth 23S of the engine cover 21 should not be high. Accordingly, a heating time would become relatively longer and accordingly, an amount of melted nonwoven cloth 23S would be increased. As a result, a part depressed by the vibration welding tool 50 in the nonwoven cloth 23S would be melted entirely in thickness direction, whereupon a rather deep depression is formed in the nonwoven cloth 23S. More specifically, the welded part and the vicinity of the welded part would remain depressed, whereupon a space among fibers would be decreased. As a result, the sound proofing performance of the engine cover would be weakened.

On the other hand, in the engine cover 21 of the embodiment, the welding protrusion 25 welding the nonwoven cloth 23S protrudes from the engine cover 21. Accordingly, the nonwoven cloth 23S is easily melted and the heating time can be rendered shorter. Accordingly, an amount of melted nonwoven cloth 23S can be suppressed. As a result, when the vibration-welding tool 50 is detached from the nonwoven cloth 23S, the nonwoven cloth 23S is restored to its original state and only a shallow gentle depression remains in the vibration-welded part as shown in FIG. 5A. Thus, according to the foregoing embodiment, the depression in the welded part of the nonwoven cloth 23S can be rendered shallower than conventional engine covers. Furthermore, a large amount of space is ensured among fibers of the nonwoven cloth 23S in the vicinity of the welded part, whereupon the noise absorbing performance can be improved. Moreover, the welding protrusion 25 includes a plurality of protruding pieces 25A and 25B protruding from the engine cover 21 and intersecting in the form of lattice. Accordingly, the protruding pieces 25A and 25B reinforce each other, increasing the strength. Consequently, the thickness of each protruding piece 25A and 25B can be reduced so that the welding protrusion 25 can be more meltable. Furthermore, the distal end face 25S of the welding protrusion 25 is broader than the distal end face 50S of the vibration welding tool 50. Consequently, even when the position of the vibration welding tool 50 varies, the distal end face 50S of the vibration welding tool 50 remains within the distal end face 25S of the welding protrusion 25, whereupon the welding strength can be stabilized.

The invention should not be limited to the foregoing embodiment. The technical scope of the invention encompasses the following embodiments. Furthermore, the invention may further be changed without departing from the scope thereof.

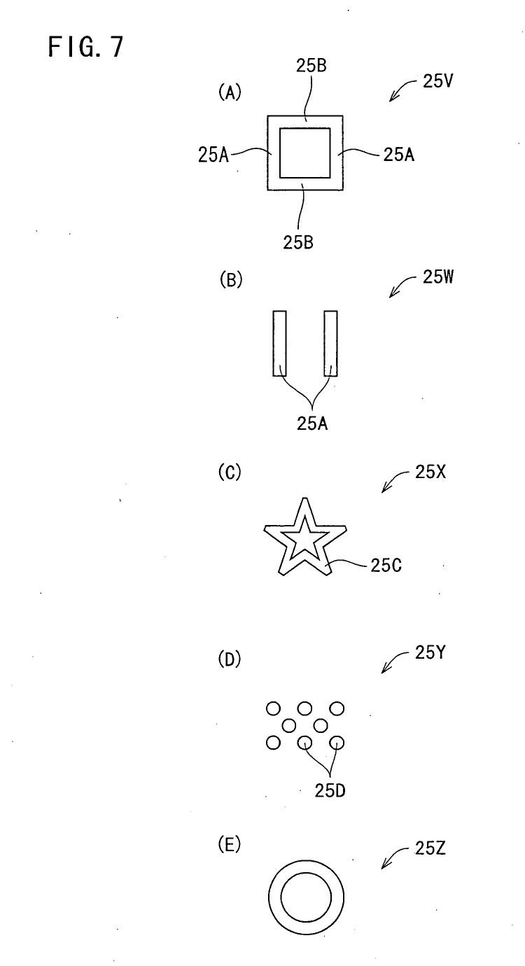

The welding protrusion 25 may be the following structure other than the structure described in the above embodiment. A welding protrusion 25V as shown in FIG. 7A may include a pair of protruding pieces 25A extending in the first horizontal direction and another pair of protruding pieces 25B extending in the second horizontal direction, both pairs are joined into a rectangular frame shape. That is, the welding protrusion may be rectangular columnar in shape. Furthermore, the welding protrusion may include only a pair of protruding pieces 25A extending in parallel with each other, shown as a welding protrusion 25W in FIG. 7B. Furthermore, five protruding pieces 25C may be joined into the shape of a pentagram as shown as a welding protrusion 25X in FIG. 7C. Furthermore, a plurality of protrusions 25D each having a circular section may be formed into an assemblage as shown as a welding protrusion 25Y in FIG. 7D. Additionally, the welding protrusion may be cylindrical as shown as a welding protrusion 25Z in FIG. 7E.

The welding protrusions 25 are dispersed on the engine cover 21 in the foregoing embodiment. The welding protrusions may be disposed uniformly in an entire area covered with the nonwoven cloth 23S of the engine cover 21. More specifically, lattice-shaped welding protrusions may be formed in the entire area covered with the nonwoven cloth 23S of the engine cover 21.

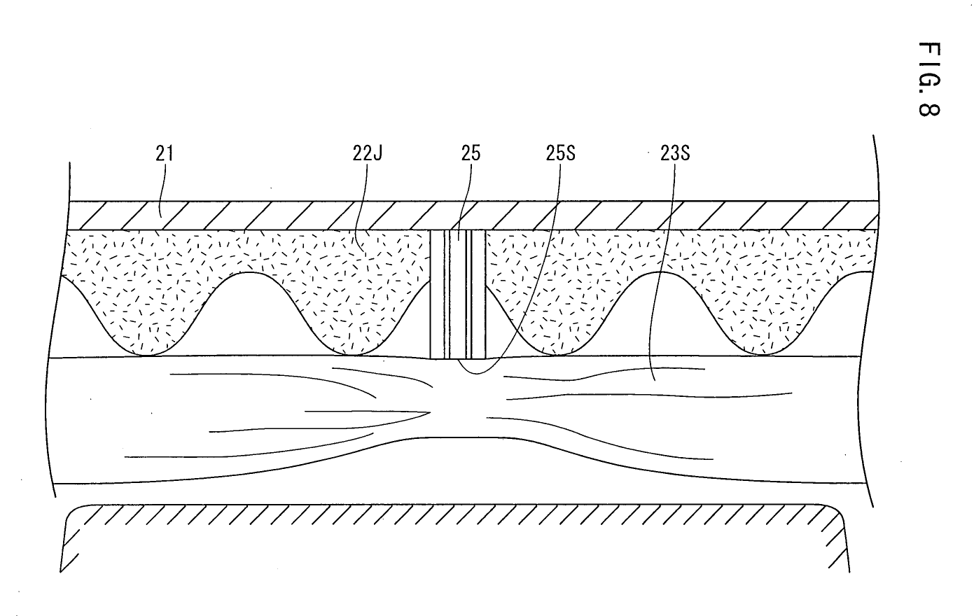

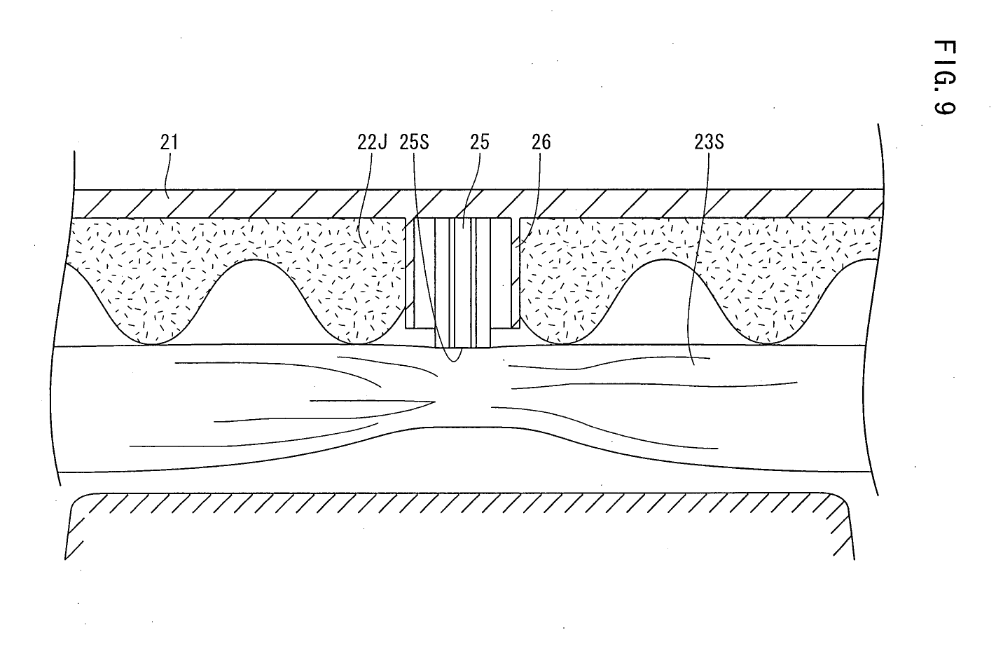

A plurality of welding protrusions 25 may be provided on a part covered with urethane resin foam 22J of the engine cover 21 as shown in FIG. 8 where only one of welding protrusions 25 is shown. Furthermore, the welding protrusions 25 may be protruded through the urethane resin foam 22J, and the nonwoven cloth 23S may be vibration-welded to the distal end faces 25S of the welding protrusions 25. Furthermore, as a modified form of the above, a cylindrical protrusion surround wall 26 may be formed so as to surround the welding protrusion 25 so that a proximal end of the welding protrusion 25 is prevented from being buried in the urethane resin foam 22J, as shown in FIG. 9.

The nonwoven cloth 23S made from PET is exemplified as the elastic resin sheet in the foregoing embodiment. The resin should not be limited to PET if a resin sheet has sufficient elasticity. Furthermore, the sheet structure should not be limited to the nonwoven cloth. Thus, an acrylic nonwoven cloth or urethane resin foam sheet is included in the elastic resin sheet.

The nonwoven cloth 23S serving as the elastic resin sheet is employed as a sound-absorbing material in the foregoing embodiment. However, the nonwoven cloth 23S may be employed as a buffer material.

The engine cover 21 is exemplified as the base member in the invention. The base member may be a dashboard of a vehicle, a casing of household electric appliance or the like.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A structure for fixing an elastic resin sheet on a base member made of a synthetic resin so that the base member is covered with the elastic resin sheet, the structure comprising a welding protrusion formed so as to protrude from a part covered with the elastic resin sheet in the base member, the welding protrusion having a distal end face to which the elastic resin sheet is vibration-welded.

2. The structure according to claim 1, wherein the base member is comprised of a sound-proof cover for covering noise source and the elastic resin sheet is comprised of a nonwoven cloth made from PET.

3. The structure according to claim 1, wherein the welding protrusion is comprised of a plurality of protruding pieces or an assemblage of the protrusions.

4. The structure according to claim 2, wherein the welding protrusion is comprised of a plurality of protruding pieces or an assemblage of the protrusions.

5. The structure according to claim 3, wherein the welding protrusion is comprised of an assemblage of a plurality of protruding pieces intersecting at right angles.

6. The structure according to claim 4, wherein the welding protrusion is comprised of an assemblage of a plurality of protruding pieces intersecting at right angles.

7. The structure according to claim 1, wherein the welding protrusion is cylindrical.

8. The structure according to claim 2, wherein the welding protrusion is cylindrical.

9. A method of fixing an elastic resin sheet on a base member made of a synthetic resin so that the base member is covered with the elastic resin sheet, the method comprising:
protruding a welding protrusion from the base member;
covering the base member with the elastic resin sheet and striking a vibration-welding tool having a bar-shaped distal end against the elastic resin sheet;
vibrating the vibration-welding tool while the elastic resin sheet is depressed between distal end faces of the vibration-welding tool and welding protrusion, thereby vibration-welding the elastic resin sheet to the welding protrusion.

10. The method according to claim 9, wherein the distal end face of the welding protrusion is broader than the distal end face of the vibration-welding tool.
